(19) United States
(12) Patent Application Publication
(10) Pub. No.: US 2018/0191168 A1
(43) Pub. Date: Jul. 5, 2018

(54) Parallel Interleaved Multiphase LLC Current Sharing Control

(71) Applicant: NATIONAL INSTRUMENTS CORPORATION, Austin, TX (US)

(72) Inventors: John G. Banaska, Spicewood, TX (US); Chin-Hong Cheah, Pulau Pinang (MY)

(21) Appl. No.: 15/861,898

(22) Filed: Jan. 4, 2018

Related U.S. Application Data
(60) Provisional application No. 62/442,037, filed on Jan. 4, 2017.

(51) Int. Cl. H02J 3/46; G05F 1/12

(52) U.S. Cl. CPC H02J 3/46; G05F 1/12

(57) ABSTRACT

A multiphase power converter may include a number of LLC converter stages coupled in a parallel interleaved current sharing configuration. The total current provided by the multiphase power converter may be balanced between the different LLC converter stages by sensing a respective output current in each LLC converter stage, with the sensed output current of one of the LLC converter stages used as a reference current, and performing one or more adjustments for each LLC converter stage (other than the reference LLC converter stage), based on the sensed output currents. The adjustments may include adjusting the input voltage provided to the LLC converter stage, the resonant frequency of the LLC converter stage, and/or the effective resonance impedance of the LLC converter stage. The ability to sense the phase current or power makes it possible to achieve balance between different LLC converter stages in a multiphase LLC-stage current sharing configuration.

### PRIORITY CLAIM

This application claims benefit of priority of U.S. Provisional Patent Application Ser. no. 62/442,037 titled “Parallel Interleaved Multiphase LLC Current Sharing Control”, filed on Jan. 4, 2017, which is hereby incorporated by reference as though fully and completely set forth herein.

### FIELD OF THE INVENTION

The present invention relates to the field of instrumentation, and more particularly to the design of parallel interleaved LLC power supplies.

### DESCRIPTION OF THE RELATED ART

A switched-mode power supply (also referred to as a switching-mode power supply, switch-mode power supply, switched power supply, or switching power supply) is an electronic power supply that incorporates a switching regulator to efficiently convert electrical power. Unlike a linear power supply, the pass transistor of a switching power supply continually switches between low-dissipation, full-on and full-off states, remaining in high dissipation transition states for only brief periods of time, thereby reducing wasted energy. Voltage regulation is typically achieved by varying the ratio of the on-state and off-state of the pass transistor(s). In contrast, a linear power supply regulates the output voltage by continually dissipating power in the pass transistor. The higher power conversion efficiency is therefore an important advantage of a switching power supply, which may also be substantially smaller and lighter than a linear power supply due to the smaller transformer size and weight.

During the development of square-wave switching power conversion (e.g. pulse width modulated—PWM—switching), concerns regarding suddenly turning OFF current passing through an inductor lead to the design of “resonant topologies”. Switching power supplies featuring one such topology are referred to as LLC power supplies. The LLC topology features a unique combination of two inductors and one capacitor (hence the name, “LLC”), and offers a relatively narrow range of switching frequencies, which make possible the design of standard EMI filters combined with the capability of producing zero-voltage switching (soft-switching) through careful design, significantly improving electromagnetic interference (EMI) and efficiency over a wide load range.

Because LLC converters are part of the resonant converter family, voltage regulation is not performed in the exact same manner as it is in conventional PWM switching power converters. Running at 50% duty-cycle and fixed 180 degree phase shift, regulation is typically obtained through frequency modulation. All primary side switches turn on resonantly—zero voltage switching—resulting in full recycling of the energy contained in the MOSFETs' parasitic output capacitance. Furthermore, all secondary side switches turn off resonantly—zero current switching—to minimize switching losses normally associated with hard switching. Resonant operation of all switching devices in the LLC converter results in minimized dynamic loss, and thus increased overall efficiency, particularly at higher operating frequencies in the hundreds of kHz to MHz range.

LLC Converters are becoming more widely accepted in offline (AC-DC) power supplies due to their high efficiency and lower component count. Adoption has been limited, however, to moderate power levels (e.g. lower than 400W). At higher power levels, traditional approaches make use of multi-phase techniques to divide component stress and reduce the size of the components. In addition, multi-phase arrangements can reduce ripple currents on output filters/capacitors, greatly extending the life of these components. This is especially important in high output-current supplies. LLC converters operate on a variable frequency control scheme to regulate line and load variation, using the slope of the gain/frequency curve to adjust the gain.

Combining the outputs of several (more than one) LLC stages naturally allows sharing the load current if the supply is operating under ZVS (zero voltage switching), the respective inductors of each stage are equal in value (e.g. in inductance) to the corresponding respective inductors of all other stages, and the respective capacitors of each stage are equal in value (e.g. in capacitance) to the corresponding respective capacitors of all other stages. Unfortunately, when the inductances and capacitances of one stage differ from the corresponding inductances and capacitances of other stages by even several percentage points, the sharing of load current can become disparate by a large amount. This difference can also be exaggerated by changes in operating frequency. Normal component manufacturing tolerances (+/−10%) are sufficient to cause unworkable differences in stage current.

Other corresponding issues related to the prior art will become apparent to one skilled in the art after comparing such prior art with the present invention as described herein.

### SUMMARY OF THE INVENTION

Various embodiments of systems disclosed herein include a novel topology/circuitry for a parallel interleaved multiphase LLC current sharing power supply system. In various embodiments, a multiphase power converter may include a number of different LLC converter stages coupled in a parallel interleaved current sharing configuration. The total sum current provided by the multiphase power converter may be balanced between the different LLC converter stages by sensing a respective output current in each LLC converter stage, with the sensed output current of one of the LLC converter stages used as a reference current, and performing one or more adjustments for each LLC converter stage other than the reference LLC converter stage, based on the sensed output currents. The adjustments may include adjusting the input voltage provided to the LLC converter stage, adjusting the resonant frequency of the LLC converter stage, and/or adjusting the effective resonance impedance of the LLC converter stage. The ability to sense the phase current, or power, therefore makes it possible to achieve balance between the different LLC converter stages in a multiphase LLC-stage current sharing configuration.

Pursuant to the above, in some embodiments, a method may be devised for controlling a number of parallel interleaved switching power supplies coupled in a current sharing configuration, where each switching power supply sources a respective portion of a total current provided by the current sharing configuration. The method may include balancing the total current between the plurality of parallel interleaved switching power supplies by sensing a respective output current in each switching power supply, where a first sensed output current corresponding to a first switching power supply is used as a reference current, and for each respective switching power supply other than the first switching power supply, adjusting, based on the first sensed output current and the sensed respective output current corresponding to the respective switching power supply, the input voltage provided to the respective switching power supply, the resonant frequency of the respective switching power supply, and/or the effective resonance impedance of the respective switching power supply.

In some embodiments, a multiphase current sharing configuration may include a number of different switching power supply stages, each switching power supply stage sourcing a respective portion of a total current provided by the current sharing configuration. The current sharing configuration may further include a number of different power factor correction stages, with one of the power factor correction stages designated as a reference stage. For each respective power factor correction stage, an output voltage of the respective power factor correction stage may be provided as an input voltage to a corresponding respective switching power supply stage, and a control circuit included in the current sharing configuration may be used to balance the total current between the plurality of switching power supply stages by adjusting the output voltage of each respective power factor correction stage except the reference stage. The output voltage of each respective power factor correction stage (except the reference stage) may be adjusted based on an output current of the respective switching power supply stage corresponding to the reference stage, and an output current of the respective switching power supply stage corresponding to respective power factor correction stage.

In some embodiments, a multiphase power converter may include a first LLC converter stage that provides a first output current having a first value, and may also include a second LLC converter stage coupled in parallel to the first LLC converter stage and providing a second output current having a second value. A total sum current including the sum of the first output current and the second output current may be provided at an output of the multiphase power converter. A control circuit included in the multiphase power converter may be operated to cause the first value to match the second value within a specified tolerance (e.g., the first value may be equal to the second value, or it may not differ from the second value by more than an specified tolerance value, etc.) In order to obtain matching values, the control circuit may obtain the first value and the second value, use the first value as a reference value, and adjust, based on the reference value and the second value, at least one of an input voltage provided to the second LLC converter stage, a resonant frequency of the second LLC converter stage, or an effective resonance impedance of the second LLC converter stage.

Other aspects of the present invention will become apparent with reference to the drawings and detailed description of the drawings that follow.

### BRIEF DESCRIPTION OF THE DRAWINGS

A better understanding of the present invention can be obtained when the following detailed description of the preferred embodiment is considered in conjunction with the following drawings, in which:

FIG. 1 shows an exemplary circuit diagram of a 2-phase power sharing configuration, according to prior art;

FIG. 2 shows an exemplary circuit diagram of a 3-phase power sharing configuration, according to prior art;

FIG. 3 shows an exemplary circuit diagram of a basic structure of a resonant LLC pulse supply topology, according to some embodiments;

FIG. 4 shows an exemplary gain versus frequency characteristic curve of the basic structure of FIG. 3, according to some embodiments;

FIG. 5 an exemplary circuit diagram of a parallel interleaved LLC pulse supply topology, according to some embodiments;

FIG. 6 shows a functional block diagram of an exemplary multiphase current sharing configuration in which multiphase current balancing is performed via adjustable PFC outputs;

FIG. 7 shows an exemplary circuit diagram of a resonant LLC pulse supply topology according to some embodiments;

FIG. 8 shows an exemplary gain versus frequency diagram for the circuit of FIG. 7, according to some embodiments;

FIG. 9 shows exemplary gain versus frequency characteristic curves of the circuit of FIG. 7, illustrating the effects on the operation of the circuit resulting from adjustments made to some of the circuit components, according to some embodiments;

FIG. 10 highlights current sensing in an exemplary circuit diagram of a parallel interleaved LLC pulse supply topology, according to some embodiments; and

FIG. 11 shows an exemplary circuit diagram of a resonant LLC pulse supply topology with switched controlled capacitors, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

Embodiments of improved power supply systems include a parallel interleaved multiphase LLC current sharing configuration providing accurate balancing of the total output current among the different power converter stages connected in the current sharing configuration.

### Previous Power Sharing Configurations

There are various power sharing configurations presently in use. The following brief descriptions are intended to provide an overview of two different impedance matching methods used to match the respective inductances and capacitances of each individual LLC power converter to the respective inductances and capacitances of all other individual LLC power converters in a power sharing configuration. As generally used herein, “matching” and “achieving balance” are used to refer to balancing the total sum current output by a multiphase power controller among the individual converters coupled together in a current sharing configuration. Such current/power balancing may include matching the respective LLC components of an LLC power converter to the respective LLC components of other LLC power converters in a power sharing configuration to obtain stage currents (a respective portions of the total current conducted by the LLC power converters in the power sharing configuration) equal to each other, or not to differ from each other by more than a specified (e.g. allowed) percentage.

### Matching by Trimming

According to one method, balance can be achieved by careful trimming of the resistive, magnetic and capacitive components of each phase of the LLC (e.g. of each LLC power converter that is a part of the power sharing configuration) to precisely match. However, this represents an expensive process for production, and is feasible only for small quantities. Factors like components aging over time will also affect the balance of the components and current balance during operation.

### Matching by ‘Floating’ Star Configuration

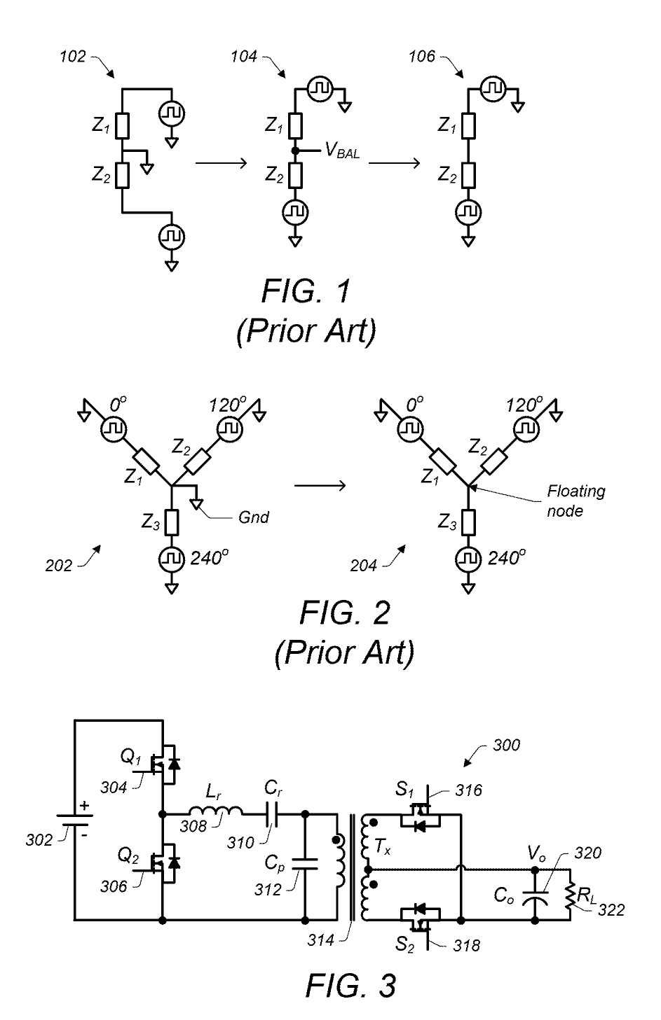

According to another previously proposed method, balance may be achieved among the different phases (e.g. among the different individual LLC power converters that are part of a power sharing configuration) by ‘floating’ the return (ground) connection of the phases connected in a ‘star’ configuration. A two-phase (2-phase) example is illustrated in FIG. 1, and a three-phase (3-phase) example is illustrated in FIG. 2.

As shown in FIGS. 1 and 2, Z₁, Z₂ and Z₃ represent each phase of the LLC power stage (or each phase of the LLC power converter stage) modelled as a load impedance. In case of the 2-Phase configuration 102 shown in FIG. 1, if the return connection between Z₁ and Z₂ is removed, as shown in configuration 104, the common node between Z₁ and Z₂ automatically achieves a balanced voltage V_{BAL}, and currents through Z₁ and Z₂ are equally shared as Z₁ and Z₂ now share what is effectively a series connection, as shown in configuration 106. This scheme can effectively be extended to multiphase configurations.

A three-phase (3-phase) configuration is illustrated in FIG. 2. In case of the 3-Phase configuration 202, if the return connection between Z₁, Z₂, and Z₃ is removed, as shown in configuration 204, the common node between Z₁, Z₂, and Z₃ becomes a floating node, which can present a balanced voltage, with equally shared currents through Z₁, Z₂, and Z₃. While this method may work well, one drawback is that each phase needs to operate at a 360 degrees/N phase shift from each other phase (where N is the number of total phases in the sharing configuration).

One advantage of multiphase LLC in general is the significant reduction of the output noise and ripple currents as the number of phases is increased. However, significant output noise and ripple current reduction may be most effectively obtained when each phase is operated at a more flexible relative phase shift with respect to each other phase than the 360 degrees/N which is required in the prior art configurations illustrated in FIGS. 1 and 2.

### Novel Power Sharing Topology

FIG. 3 shows the basic structure of an exemplary resonant LLC pulse supply topology (or LLC [switching] power converter topology) 300 according to some embodiments. The circuit of LLC converter 300 includes resonance inductor 308 and resonance capacitor 310. As illustrated in circuit 300, together with resonance inductor 308 and resonance capacitor 310, voltage source 302, primary side upper switch 304, primary side lower switch 306, secondary side upper switch 316, and secondary side lower switch 318 are used for controlling the voltage V_{O} developed across the load represented by load resistance 322, with the output capacitance across the load represented by capacitor 320. C_{O} represents the parasitic capacitance 312 across the primary winding (or winding on the primary side) of the transformer 314.

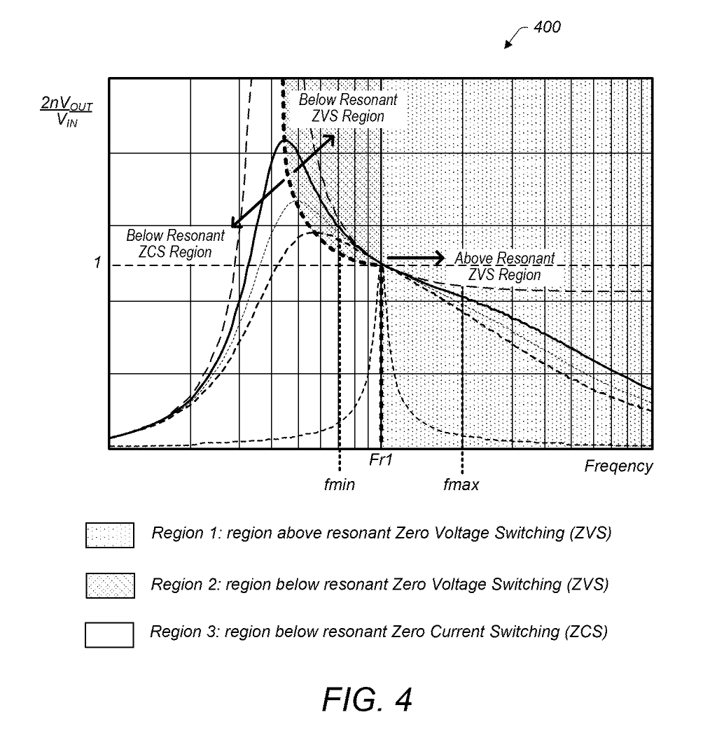

An LLC converter is essentially a frequency driven power supply, with a resulting gain curve illustrated in the exemplary voltage versus frequency diagram 400 shown in FIG. 4, according to some embodiments. Diagram 400 illustrates the relationship between the input voltage and upper voltage versus the operating frequency. The resonant frequency is indicated as Fr1, the minimum frequency is indicated as fmin, and the maximum frequency is indicated as fmax. Diagram 400 illustrates three operating regions. Region 1 is the region above resonant zero voltage switching (ZVS), region 2 is the region below resonant ZVS, and region 3 is the region below resonant zero current switching (ZCS).

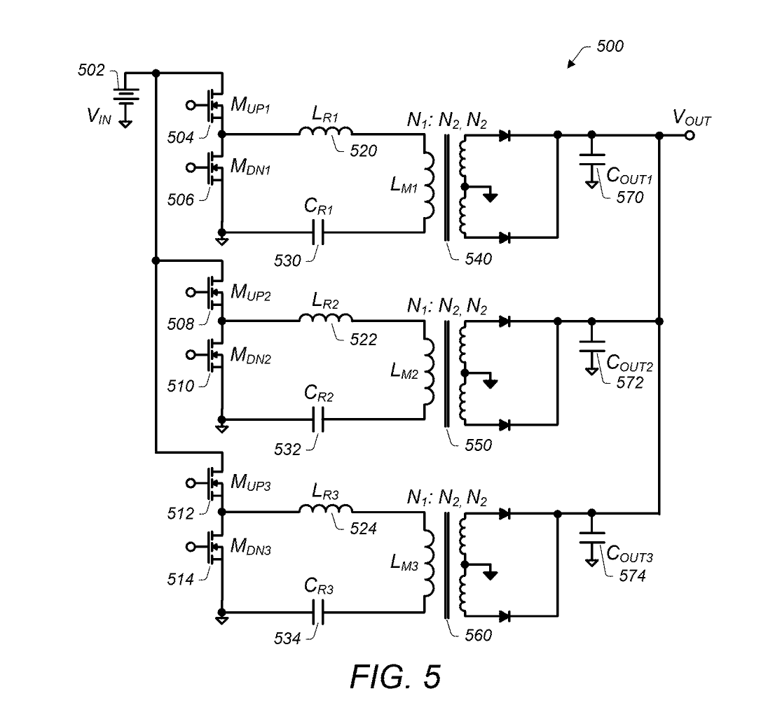

Operation of a single LLC stage is considered simple with the use of a control loop to adjust the gain by varying the frequency of the LLC oscillator, to achieve the desired gain that maintains the desired output voltage (i.e., it provides a regulated output voltage). However, as shown in FIG. 5, when at least a couple of LLC power converter stages are coupled in parallel, the operation of the resulting system is no longer as simple as in the case of a single LLC stage (or single LLC power converter stage). FIG. 5 illustrates a multi-stage power sharing configuration 500 that includes three LLC power converter stages, according to some embodiments. A first LLC stage includes primary side upper switch 504, primary side lower switch 506, resonant inductor 520, resonant capacitor 530, a transformer 540 with primary winding L_{M1}, with the output capacitance of the secondary (output stage) illustrated by capacitor 570. A second LLC stage includes primary side upper switch 508, primary side lower switch 510, resonant inductor 522, resonant capacitor 532, a transformer 550 with primary winding L_{M2}, with the output capacitance of the secondary (output stage) illustrated by capacitor 572. Finally, a third LLC stage includes primary side upper switch 512, primary side lower switch 514, resonant inductor 524, resonant capacitor 524, a transformer 560 with primary winding L_{M3}, with the output capacitance of the secondary (output stage) illustrated by capacitor 574. The supply voltage is provided by input voltage supply 502.

The final output voltage of each LLC stage may have slight variations resulting from the tolerances (e.g. slight differences) between respective corresponding resonant components in the different stages, e.g. tolerances between the resonant capacitors (530, 532, 534), and between the resonant inductors (520, 522, 524). In a parallel LLC structure as shown in FIG. 5, this may cause a power output imbalance between the parallel stages and reduced efficiency of the parallel stages. In one set of embodiments, balance of (or between) the output stages (the LLC stages) may be achieved according to at least two different methods, both of which are directed to balancing the final output voltage V_{OUT} amongst the output (LLC) stages by adjusting the gain curve(s) previously illustrated in FIG. 4.

The difference between the two methods, which will be further described in detail below, is in the means used to achieve the final output voltage balance between the stages. One of the goals is to maintain the desired phase difference between the stages, to maximize output ripple cancellation, without changing the fundamental operating frequency between the stages. In other words, adjustments to the operation of the stages are made in a manner that ensures that the operating frequency remains the same across the different LLC stages. It should also be noted that the various embodiments of multiphase LLC current sharing control disclosed herein are not necessarily limited to just three-stage LLC multiphase configurations and may be extended from a two-stage LLC multiphase configuration to any number (N) of LLC stages. In both methods, the adjustments may be implemented dynamically via a secondary feedback loop that is slower than the main voltage (primary) feedback loop of the multiphase LLC. While the various embodiments disclosed herein require no initial calibration when performing dynamic adjustments, other embodiments may implement an initial calibration performed to eliminate component imbalances according to the methods described herein without making dynamic adjustments.

### Parallel Interleaved LLC, Method I: Adjustable PFC Vₒᵤₜ

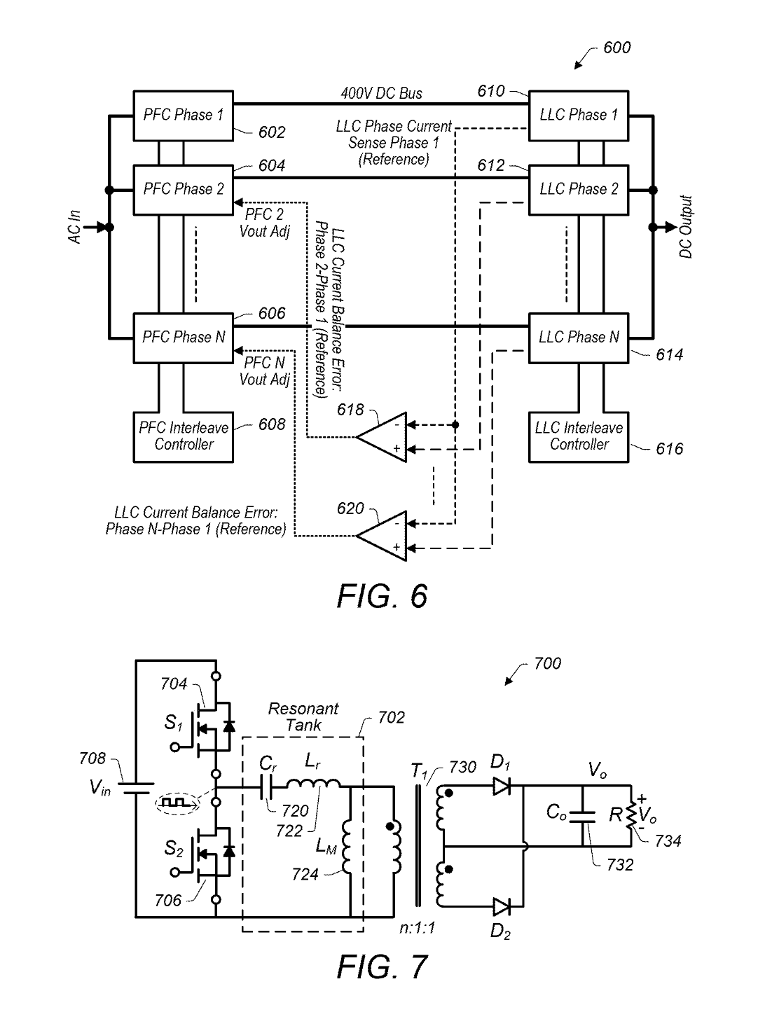

In some embodiments, respective power factor correction (PFC) stages may be used to provide input voltages to corresponding the LLC stages in a power supply topology derived from the parallel LLC power sharing configuration 500 illustrated in FIG. 5. Starting with a parallel multiphase topology (e.g. configuration 500) that includes a specified number (N) of LLC power converter stages, N PFC stages may be coupled to the N LLC stages downstream. FIG. 6 shows a functional block diagram of an exemplary multiphase current sharing configuration 600 in which multiphase current balancing is performed via adjustable PFC outputs, according to some embodiments. The illustrated multiphase LLC power sharing configuration 600 includes LLC power converters (phases) 1 through N (indicated as 610, 612, and 614, respectively), with control provided by an LLC interleave controller 616. The configuration 600 also includes corresponding PFC stages 1 through N (indicated as 602, 604, and 606, respectively), with control provided by PFC interleave controller 608. The input voltage to each LLC phase (stage) is provided by the corresponding PFC phase as shown. For example, the output voltage of PFC phase 1 (602) is provided as the input voltage of LLC phase 1 (610), the output voltage of PFC phase 2 (604) is provided as the input voltage of LLC phase 2 (612), and so on up to PFC phase N (606) and LLC phase N (614). Thus, one difference between the power sharing configuration 500 shown in FIG. 5 and the power sharing configuration 600 shown in FIG. 6 is that while power sharing configuration 500 features a single input voltage source 502 providing the input voltage to each LLC stage, in the power sharing configuration 600 shown in FIG. 6, the output voltage of a PFC phase (stage) is used as the input voltage for a corresponding LLC phase. Thus, each LLC phase (stage) receives an individual input voltage instead of a single source (e.g. source 502 shown in FIG. 5) providing the input voltage to all the LLC phases (stages).

The current output (or output current) of each LLC phase (LLC stage) may be measured, and one of the LLC phases may be used as a reference to obtain error information corresponding to the other LLC phases (or to the respective output currents of the other LLC phases). As shown in FIG. 6, LLC phase 1 is used as the reference phase, with the measured output current of LLC phase 1 used as the reference current. The measured output current of LLC phase 1 may be compared with the measured output current of LLC phase 2, e.g. by using a comparator 618, and the resulting difference in current values may be reported back to PFC phase (stage) 2 for making an adjustment, if necessary, to the output voltage of PFC phase 2, based on the reported difference in current values. The same may be performed for all respective PFC phase/LLC phase pairs, with a final PFC phase N (606) and LLC phase N (614) using comparator 620 to compare the measured output current of LLC phase 1 with the measured output current of LLC phase N. In general, the error information may be used to make adjustments to the respective output voltages of the non-reference PFC phases (e.g. PFC phases 2 through N in the case shown in FIG. 6) such the output voltage of all the respective PFC phases (602, 604, 606) are varied slightly to cancel out the current imbalance in the respective outputs of the corresponding LLC phases (610, 614, 616).

According to this method, the gain curves of the respective LLC phases may still be mismatched, and the input voltage to each of the LLC phases may be adjusted such that the output voltage (DC output) is matched. A matched output voltage between the LLC phases is achieved when the respective error output corresponding to the output current of each non-reference LLC phase is zero, effectively achieving equal power (or achieving a power balance) between all the LLC phases. The PFC phases and the LLC phases need not be linked or operate at the same frequency in the power sharing configuration 600 shown in FIG. 6.

### Parallel Interleaved LLC, Method II: Adjustable Effective Resonance Impedance

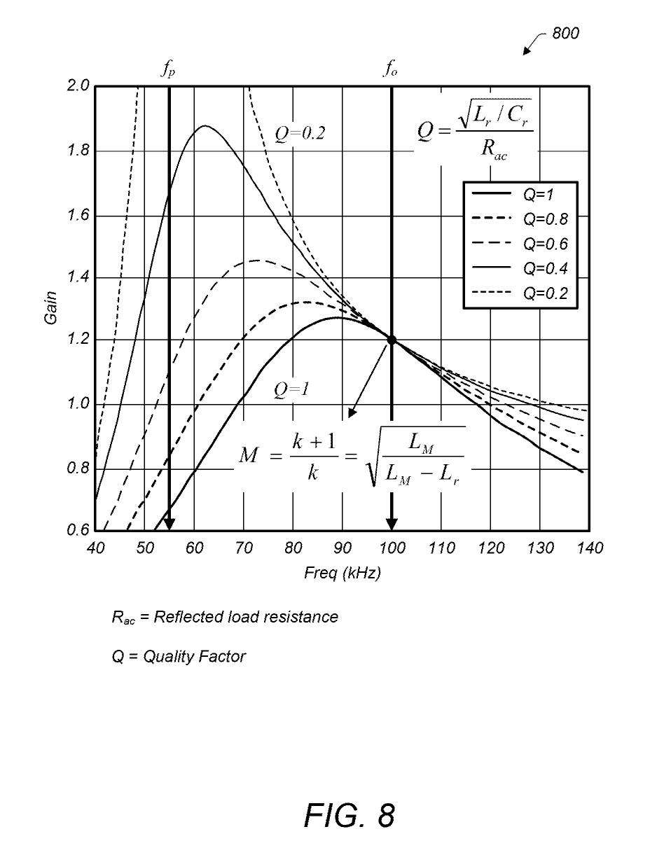

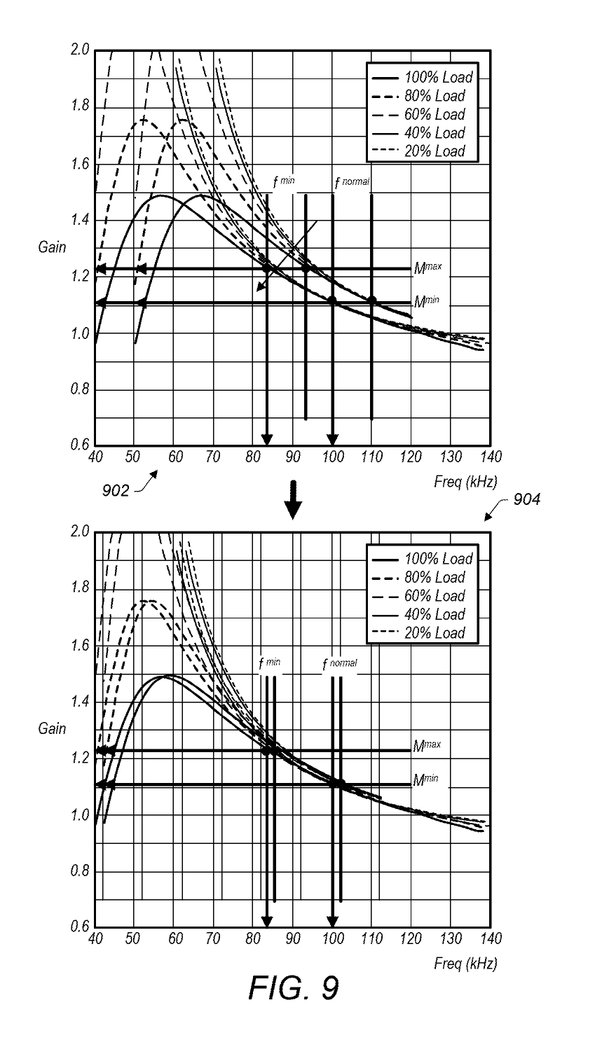

In some embodiments, according a second method, balance between the different LLC stages (phases) may be achieved by adjusting the effective resonance impedance (e.g. one or more of the component values of the resonant tank) in each LLC stage as may be necessary to achieve balance between the different LLC stages. FIG. 7 shows an exemplary circuit diagram of a resonant LLC pulse supply (LLC stage) topology 700 according to some embodiments. The resonant LLC supply 700 includes a transformer 730 having a primary side (winding) receiving an input voltage input voltage from source 708, with primary side upper switch 704 and lower switch 706 used for switching control of the output voltage V_{O} across load 734 (exemplified by a resistor R, also indicating an output capacitance 732) at the secondary side (winding) of transformer 730. LLC supply also includes a resonant tank 702 with resonant capacitor Cr 720, resonant inductor Lr 722 and primary (or main) inductance Lm 724 as shown. Overall, the resonant tank may be considered as representative of the effective resonance impedance of the LLC stage 700. FIG. 8 shows an exemplary gain versus frequency characteristic diagram for the LLC stage 700 of FIG. 7, featuring different gain versus frequency curves for different quality factor values, according to some embodiments.

The respective value(s) of any one or more of the components in resonant tank 702 may be adjusted (changed) to adjust (change) the quality factor (Q), a ratio between primary inductance and resonant inductance (M), and the gain of the LLC converter (or Vₒᵤₜ/Vᵢₙ) for a fixed operating frequency. Maintaining a common operating frequency across the multiple LLC phases may ensure output ripple cancellation as previously outlined above.

In some embodiments, the effective value of Cr 720 may be adjusted to balance the LLC phases. However, in various other embodiments, the respective values of the other LLC resonant components (e.g. Lᵣ 722 and/or L_{M} 724) may be adjusted to achieve the same effect, making dynamic adjustments (changes) to the LLC gain curves. The resonant capacitor values (or resonant capacitances) may be adjusted based upon the current-balance error information (which may be obtained as described above with respect to the first method), effectively adjusting the gain curves of each resonant LLC stage to balance out the tolerances, as illustrated in FIG. 9. Because the value of the resonant capacitor (or the resonant capacitance) directly affects (and hence may be used to adjust) the resonant frequency (Fri) of each of the LLC stages, the gain of each of the LLC phases may be directly adjusted such that a balance between the LLC phases is achieved. As shown in the gain diagram of FIG. 9, effective adjustments may be made to Cr to align the gain at the operating frequency of multiple LLC phases. When LLC phases are balanced in this manner, the respective resonant frequencies of the LLC phases may slightly differ from each other, but during static operation they all have the same operating gain, and therefore achieve the same output voltage for a fixed input voltage.

### Current Sensing (Measurement)

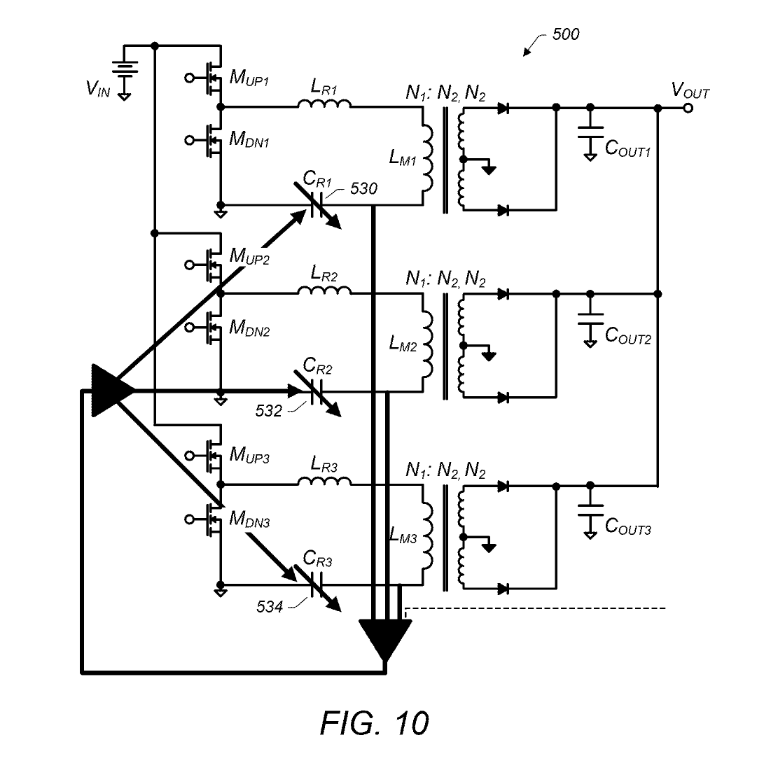

In order to sense the phase currents, or the respective output currents of the LLC phases (stages), traditional resistor sense strategies may be employed. However, when using such traditional strategies, efficiency may suffer due to resistive losses. Thus, in some embodiments, an alternative current sensing strategy may be used. As shown in FIG. 10, sensing resonant capacitor voltage (which varies as a function of load current) provides a low-loss alternative to sensing resistance voltage. Accordingly, using the current sharing configuration 500 as an example, respective resonant capacitor voltages may be sensed in resonant capacitors 530, 532, and 534 as illustrated in FIG. 10. In various embodiments, it may also be possible to use inductive current sensing. The sensors may not be required to directly indicate current, only to respond to the current in an indicative manner, e.g. in a manner that tracks and indicates changes in the current. For example, equal sense signals on all sensors may be indicative of a balanced system within the matching of the sensors.

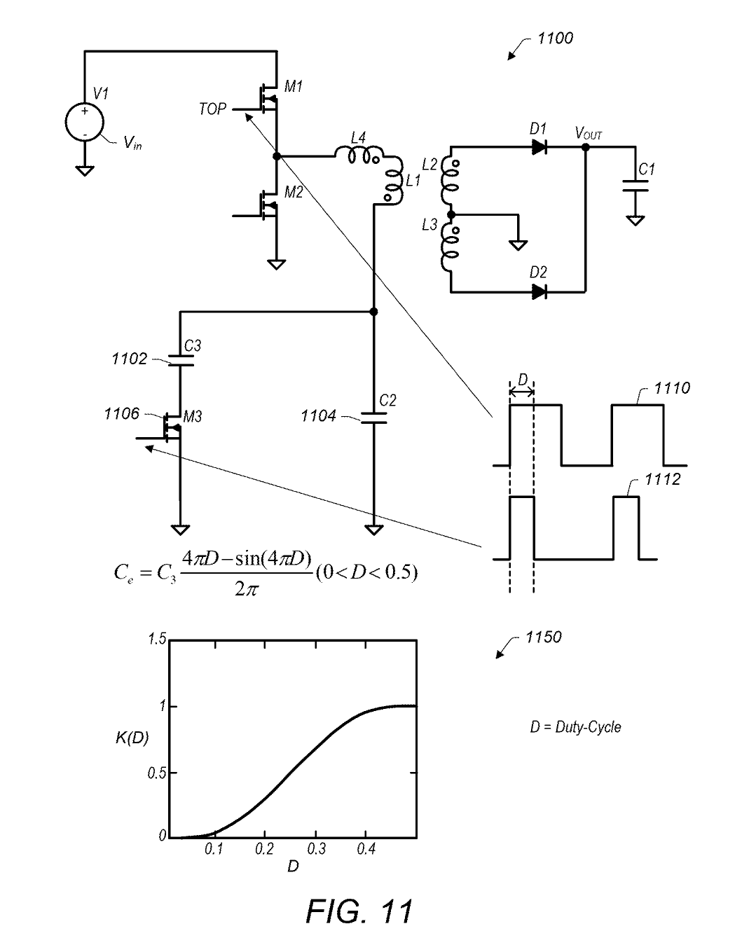

FIG. 11 shows an exemplary circuit diagram 1100 of a resonant LLC pulse supply topology with switch-controlled capacitors, according to some embodiments. A switch-controlled capacitor circuit including capacitors 1102 and 1104, as well as switch M3 (1106) may be used to implement an adjustable effective resonant capacitance Cₑ in LLC supply circuit 1100. In an exemplary embodiment, capacitor 1102 may have a value of 10 nF and capacitor 1104 may have a value of 33 nF. As shown in FIG. 11, switch M3 (1106) is driven with a square wave synchronous to the loop clock (switching frequency). The duty cycle of the waveform may be adjusted, for example between 0 and 0.5, to vary the amount of capacitance that appears in parallel with capacitor 1104, as illustrated in diagram 1150. In this manner, the effective resonant capacitance Cₑ may be adjusted to move the gain, and balance the load with other LLC phases. The top switch M1 (e.g. a Field Effect Transistor gate) may be driven by a signal with a 50% duty-cycle at the LLC switching frequency, Fsw. If M3 is also driven with the correct phase relationship with respect to M1 and M2, M3 may be operating under ZVS conditions, maximizing efficiency.

It should be noted that M3 takes advantage of the positive bias on capacitor 1104 to make use of only one switching device. Various embodiments featuring a series switch arrangement are also possible and are contemplated. It is also possible to allow the LLC phases to adjust “differentially” in order to maximize the gain control effect. For example, the duty-cycle in one LLC phase may be reduced while the ratio in the other LLC phase is increased, doubling the effect or reducing the required size of capacitor 1102 by a specified factor, for example by a factor of 2. The ability to sense phase current or power makes it possible to achieve balance between the different LLC stages in a multiphase LLC stage current sharing configuration. In other embodiments (not shown), and extra inductor may be duty-cycle switched (similar to the switch-controlled capacitor circuit) in order to adjust the resonant frequency Fr (in a manner similar to how thr Cr is adjusted in FIG. 11), facilitating balance between phases.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for controlling a plurality of parallel interleaved switching power supplies coupled in a current sharing configuration, wherein each switching power supply sources a respective portion of a total current provided by the current sharing configuration, the method comprising:
balancing the total current between the plurality of parallel interleaved switching power supplies, said balancing comprising:
sensing a respective output current in each switching power supply of the plurality of switching power supplies, wherein a first sensed output current corresponding to a first switching power supply of the plurality of switching power supplies is a reference current; and
for each respective switching power supply other than the first switching power supply, adjusting, based on the first sensed output current and the sensed respective output current corresponding to the respective switching power supply, at least one of:
an input voltage provided to the respective switching power supply;
a resonant frequency of the respective switching power supply; or
an effective resonance impedance of the respective switching power supply.

2. The method of claim 1, wherein said adjusting the effective resonance impedance of the respective switching power supply comprises adjusting a resonant capacitance of the respective switching power supply.

3. The method of claim 2, wherein said adjusting the resonant capacitance of the respective switching power supply comprises:
driving a switch with a square wave synchronous to a switching frequency of the respective switching power supply, wherein the switch and a first capacitor are coupled in series to form a switch-controlled capacitor configuration, and wherein a second capacitor is coupled in parallel with the switch-controlled capacitor configuration; and
adjusting a duty-cycle of the square wave to vary a capacitance that appears in parallel with the second capacitor.

4. The method of claim 1, wherein said adjusting the resonant frequency of the respective switching power supply comprises adjusting an effective resonance inductance of the respective switching power supply.

5. The method of claim 1, further comprising:
for each respective switching power supply of the plurality of switching power supplies:
providing, as the input voltage to the respective switching power supply, a respective output voltage of a corresponding respective power factor correction stage;
wherein said adjusting the input voltage provided to the respective switching power supply comprises adjusting the respective output voltage of the corresponding respective power factor correction stage.

6. The method of claim 1, wherein said adjusting based on the first sensed output current and the sensed respective output current corresponding to the respective switching power supply comprises adjusting based on an error value derived from a difference between the first sensed output current and the sensed respective output current corresponding to the respective switching power supply.

7. The method of claim 1, wherein said sensing the respective output current in each switching power supply comprises sensing a respective voltage across a respective resonant capacitor of each switching power supply.

8. A multiphase current sharing configuration comprising:
a plurality of switching power supply stages, wherein each switching power supply stage is configured to source a respective portion of a total current provided by the current sharing configuration;
a plurality of power factor correction stages comprising a first power factor correction stage that is a reference stage, wherein for each respective power factor correction stage:
an output voltage of the respective power factor correction stage is configured to be provided as an input voltage to a corresponding respective switching power supply stage; and
control circuitry configured to balance the total current between the plurality of switching power supply stages by adjusting the output voltage of each respective power factor correction stage except the reference stage, wherein adjusting the output voltage of each respective power factor correction stage except the reference stage, comprises:
adjusting the output voltage of the respective power factor correction stage based on an output current of the respective switching power supply stage corresponding to the reference stage, and an output current of the respective switching power supply stage corresponding to respective power factor correction stage.

9. The multiphase current sharing configuration of claim 8, wherein adjusting the output voltage of the respective power factor correction stage based on an output current of the respective switching power supply stage corresponding to the reference stage, and an output current of the respective switching power supply stage corresponding to respective power factor correction stage, comprises:
adjusting the output voltage of the respective power factor correction stage based on an error value derived from a difference between the output current of the respective switching power supply stage corresponding to the reference stage, and the output current of the respective switching power supply stage corresponding to respective power factor correction stage.

10. The multiphase current sharing configuration of claim 8, further comprising:
sense circuitry configured to provide, for each power factor correction stage, a value of the output current of the respective switching power supply stage corresponding to the respective power factor correction stage.

11. The multiphase current sharing configuration of claim 10, wherein to provide the value of the output current of the respective switching power supply stage corresponding to the respective power factor correction stage, the sense circuit is configured to measure a voltage across a respective resonant capacitor of the respective switching power supply stage.

12. The multiphase current sharing configuration of claim 11, wherein the respective resonant capacitor is a switch-controlled capacitor circuit having an adjustable capacitance value.

13. The multiphase current sharing configuration of claim 12, wherein the switch-controlled capacitor circuit comprises:
a first branch comprising a switch coupled in series with a first capacitor; and
a second branch coupled in parallel with the first branch and comprising a second capacitor;
wherein the switch is configured to be driven with a square wave synchronous to a switching frequency of the respective switching power supply stage; and
wherein adjusting a duty-cycle of the square wave adjusts a capacitance of the switch-controlled capacitor circuit.

14. A multiphase power converter comprising:
a first LLC converter stage configured to provide a first output current having a first value;
a second LLC converter stage coupled in parallel to the first LLC converter stage and configured to provide a second output current having a second value;
an output node configured to provide a sum current comprising the first output current and the second output current; and
control circuitry configured to cause the first value to match the second value within a specified tolerance, wherein to cause the first value to match the second value, the control circuitry is configured to:
obtain the first value and the second value;
use the first value as a reference value; and
adjust, based on the reference value and the second value, at least one of:
an input voltage provided to the second LLC converter stage;
a resonant frequency of the second LLC converter stage; or
an effective resonance impedance of the second LLC converter stage.

15. The multiphase converter of claim 14, wherein to adjust the effective resonance impedance of the second LLC converter stage, the control circuitry is configured to adjust a resonant capacitance of the second LLC converter stage.

16. The multiphase converter of claim 15, wherein to adjust the resonant capacitance of the second LLC converter stage, the control circuitry is configured to:
drive a switch with a square wave synchronous to a switching frequency of the second LLC converter stage, wherein the switch and a first capacitor are coupled in series to form a switch-controlled capacitor configuration, and wherein a second capacitor is coupled in parallel with the switch-controlled capacitor configuration; and
adjust a duty-cycle of the square wave to vary a capacitance that appears in parallel with the second capacitor.

17. The multiphase converter of claim 14, wherein to adjust the resonant frequency of the second LLC converter stage, the control circuitry is configured to adjusting an effective resonance inductance of the second LLC converter stage.

18. The multiphase converter of claim 14, further comprising:
a first power factor correction stage configured to generate a first output voltage and provide the first output voltage as an input voltage to the first LLC converter stage; and
a second power factor correction stage configured to generate a second output voltage and provide the second output voltage as the input voltage to the first LLC converter stage;
wherein to adjust the input voltage provided to the second LLC converter stage, the control circuitry is configured to adjust the second output voltage based on an error value obtained from a difference between the reference value and the second value.

19. The multiphase converter of claim 14, wherein to obtain the first value and the second value, the control circuitry is configured to sense the first output current and the second output current.

20. The multiphase converter of claim 19, wherein to sense the first output current, the control circuitry is configured to sense a first voltage developed across a resonance capacitor of the first LLC converter stage; and
wherein to sense the second output current, the control circuitry is configured to sense a second voltage developed across a resonance capacitor of the second LLC converter stage.
